(19) United States
(12) Patent Application Publication
(10) Pub. No.: US 2008/0115594 A1
(43) Pub. Date: May 22, 2008

(54) High temperature enclosure system for flare gas sampling

(75) Inventors: Guyer Lee Kohlhagen, Pasadena, CA (US); Mu Hong Kim, Monterey Park, CA (US); Amin Solehjou, Laguna Niguel, CA (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: Mangan, Inc.

(21) Appl. No.: 11/657,752

(22) Filed: Jan. 25, 2007

Related U.S. Application Data
(60) Provisional application No. 60/859,767, filed on Nov. 16, 2006.

(51) Int. Cl. G01N 1/22

(52) U.S. Cl. 73/863.11

(57) ABSTRACT

A heated sample pump enclosure maintains a regulated high temperature for the head of a pump as well as a plurality of sample lines that pass through it. The pump receives a flare sample from a process line and then discharges it to any number of external devices while maintaining a constant temperature, as it is being switched and routed within the heated enclosure. There are electrical, thermo and process safety shutdown systems that regulate and monitor the process within the enclosure by means of electrical instrumentation and temperature controls. The enclosure as well as the required equipment is preferably packaged as a unit.

### CROSS-REFERENCE TO RELATED APPLICATIONS

This application takes priority from U.S. Provisional Application Ser. No. 60/859,767 filed Nov. 16, 2006.

### BACKGROUND OF THE INVENTION

1. Field of the Invention

The present invention relates generally to the field of oil refineries and specifically to the field of flare gas sampling wherein a sampling gas pump head is provided in an enclosure along with a plurality of sample lines while the enclosure interior is maintained at a constant high temperature to improve the accuracy of sampling analysis.

2. Background Art

Flares are primarily intended as safety and pollution control devices. They burn gases that cannot be used by the refinery and prevent their direct release to the atmosphere.

A number of different devices may be called flares. A flare, as defined, is a combustion device that uses an open flame to burn combustible gases with combustion air provided by uncontrolled ambient air surrounding the flame. The term is most commonly applied to the open-air flare. It is also commonly applied to ground flares, which are located at ground level and typically have an enclosure around the open flame. The term “enclosed flare” may also be applied to this type of flare, regardless whether it is located at ground level. Flares, whether “open air”, “ground”, or “enclosed”, rely on surrounding air for combustion and do not have any mechanism for control of this combustion air.

Flares are used in the oil refinery industry to burn off product that has been discharged to the flare manifold. This occurs when there is an upset in the process resulting in product that needs to be eliminated from the system to restore equilibrium. Product that is sent to the flares can either be gas or liquid. The exact nature of the product is dependent on which refining process has experienced an upset. A flare manifold is the piping system that is used by various process units to dump product to an assigned flare for that particular unit.

It is necessary to monitor the product that is being discharged to the flares for air quality concerns. To accomplish this sampling of what actually travels to a flare during an event, that is when a flare actually “flares” burning off product, a probe is inserted into the flare manifold to take a sample of the product. This sample is delivered to an analyzer via heated tubing. This heated line is encapsulated in insulation with a protective outer sheathing to insure that the temperature of the sample is delivered to the analyzer at a temperature that enables the analyzer to accurately determine the chemical composition of the sample. This information is then relayed to an air quality agency for their monitoring of air quality.

There are several different components that can be analyzed from the flare manifold, but each one requires its own analyzer, heated tube bundle, pumps, and probes. Thus if several different components were being monitored at a particular flare, there would be a corresponding system for sampling, delivery and analyzing for each component.

This current approach is intrinsically flawed for two main reasons. First, this multiplicity of sampling raises the question of quality. Are all the samples identical in composition, quality and temperature, so that a true reading can be achieved that accurately reflects what is being burned off into the atmosphere and is consistent across all the samples taken? Secondly there exists the added expense of multiple sampling systems. This includes, but is not limited to, problems encountered with the existing infrastructure, the availability of being able to insert multiple probes into a flare manifold and other associated issues.

Current technology also doesn't address the issues associated with hazardous environments encountered at a flare site with the requirement to maintain a flare sample at high temperatures. In order to deliver the sample to the analyzer from the probe, a sample pump is used to suction the sample at the probe into the analyzer. The head of the pump is required to maintain the same temperature as the sample it is pulling into the analyzer. Most commonly used pumps with heated heads maintain temperatures of 150° F. These same pumps should also be required to operate in hazardous locations. This poses real problems if the sample has to be produced at higher temperatures in the range of 250-300° F.

A brief discussion of hazardous areas is essential to understand the importance of this aspect of the refining environment. Article 500 through 510 of the NEC (National Electrical Code) discusses what a hazardous area is, what the different classifications require for construction of electrical devices and how to mitigate the dangers of operating electrical equipment in an explosive environment. For the purpose of our discussion we are concerned with Class 1, Division II, Groups B, C and D as defined by the National Electrical Code (NEC), Article 500.

Article 500.B defines Class 1 “Class 1 locations are those in which flammable gases or vapors are or may be present in the air in quantities sufficient to produce explosive or ignitable mixtures.” This true for areas surrounding flares. Article 500.2.1. defines Division 2 as a location “In which volatile flammable liquids or flammable gases are handled, processed, or used, but in which the liquids, vapors or gases will normally be confined within closed containers or closed systems from which they can escape only in case of accidental rupture or breakdown of such containers or systems or in case of abnormal operation of equipment, Or (2) In which ignitable concentrations of gases or vapors are normally prevented by positive mechanical ventilation and which might become hazardous through failure or abnormal operation of the ventilating equipment.” The classification of Groups is based upon the explosiveness of different flammable gases or vapors. Typically, Group A refers to Acetylene, Group B Hydrogen, Group C Ethylene and Group D Propane. A flare could have any of the products listed in the NEC tables for groups B, C and D at any time depending on which one of the units is dumping product to the flare during an upset.

The piping comprising the flare manifold and the heated tubing delivering the sample to the analyzer, constitute “closed systems”. In normal operating conditions there is little danger of vapors, liquids or gases escaping these systems, but if a leak should occur, these vapors, gases or liquids would be present in the necessary quantities for an explosive environment. The present invention is designed so that the atmosphere inside of the enclosure, even though attaining temperatures of 300° F., is devoid of explosive vapors, gases and liquids through such means as positive pressure and mechanical ventilation. And if there should be an accidental release, there are a number of shutdown systems in place, one of which is referred to as “mechanical ventilation” which would prevent the concentration of ignitable gases, vapors or liquids reaching the point of auto-ignition.

The present invention successfully addresses all three of the issues raised in the aforementioned discussion. It requires only one sampling point, thus it reduces the cost of installation by using only one probe, one delivery system and one sampling pump. It also delivers the sample to the analyzer at the required higher temperature, 300° F., while maintaining an area classification that mitigates hazardous environments where it has been designed to operate.

### SUMMARY OF THE INVENTION

The present invention is comprised of the following elements: a pump, a heated enclosure and various types of instrumentation that monitor the processes within the enclosure.

A principal component is the heated pump enclosure. This is a stainless steel box that is insulated. The head from the sample pump projects into this enclosure so that the suction and discharge lines connected to it are always maintained at the desired high temperature. A heater is also present in this enclosure. This heater is adjusted by a means of an external temperature controller that monitors and adjusts the heater. Pressurized air is forced past the heater element and is distributed inside the enclosure to prevent cold spots. The heated tube bundle from the flare probe is routed to the sample pump suction side by stainless steel tubing that has been stripped of its insulation. The tubing containing the sample is not insulated while being routed inside the heated enclosure. The stripping of its insulation occurs prior to its entry into the enclosure. Once the tubing enters the enclosure it must be kept at the temperature necessitated by the analyzer process. Once the stainless steel tubing containing the sample from the probe is discharged from the sample pump, it can be routed to as many analyzers or peripheral devices as required. However, once a heated sample line leaves the heated enclosure, it must again be insulated and have its temperature controlled to insure that the sample is maintained at the desired viscosity.

To prevent the possibility of an explosive atmosphere developing inside the heated enclosure, certain preventive initiatives have been taken. If a leak occurs inside the heated enclosure, the positive air pressure maintained inside the enclosure does not allow the vapor, gas or liquid to build to an explosive concentration. It is instead forced out a vent that is built into the enclosure. Another scenario where an explosion could occur is if the vapors or gasses were allowed to come into contact with the heater element. However this is prevented because air is forced pass the heater element into the enclosure, creating positive pressure, thus not allowing any vapors to “backtrack” to the heater. In the event that the plant air should fail, thus losing the positive air pressure going over the heater element, there is a back-up line to bottled air that is automatically switched to by means of mechanical interlocks. Thus the positive air pressure across the heater is maintained. If this should occur, the inventive enclosure turns itself off, gradually cooling off while the heater has been turned off, not allowing it to continue operating while the plant air is off.

The instrumentation that is associated with this enclosure, monitor pressure of the pump on the suction and discharge side, flow, temperature of the enclosure, air pressure inside of the enclosure, and temperature to the heater. If the heater should fail, a mechanical process is in place that allows the enclosure to cool off while maintaining the correct atmosphere inside of the enclosure.

As discussed earlier, in prior installations a separate heated sample line is required for each analyzer installed. This necessitated duplication of effort as well as materials. This same system was not designed to operate in Class 1, Division 2, groups B, C & D with temperatures in excess of 150° F. This is because of fears for auto-ignition of explosive vapors gases or liquids that are being analyzed.

In the present invention, only one sample line is required to feed one sample pump. After the sample line has been discharged by the pump, it can run to as many analyzers as desired, hence one probe, one delivery line, one pump, and a multiplicity of devices can be fed from one sample. This insures the readings of the analyzers are from the same sample regardless of what components are being analyzed. This is done while maintaining high temperatures in a Class 1, Division 2, Groups B, C & D area.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 illustrates the prior art method of gathering samples from the flare manifold and distributing the sample to the various analyzers involved;

FIG. 2 identifies the inventive Heated Pump Assembly as the sole recipient of the heated tube line from the only probe mounted on the flare manifold;

FIG. 3, consisting of FIGS. 3A, 3B and 3C, is an interior view of the Heated Pump Assembly; and

FIG. 4 is an exterior view of the Heated Pump Assembly.

### DETAILED DESCRIPTION OF A PREFERRED EMBODIMENT

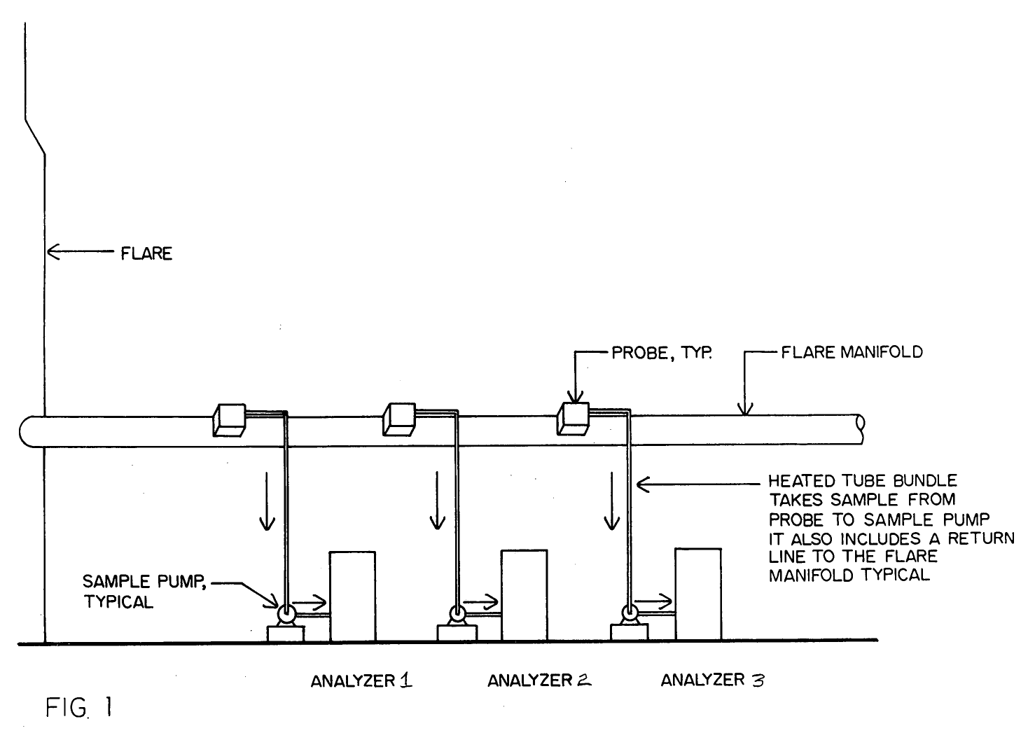

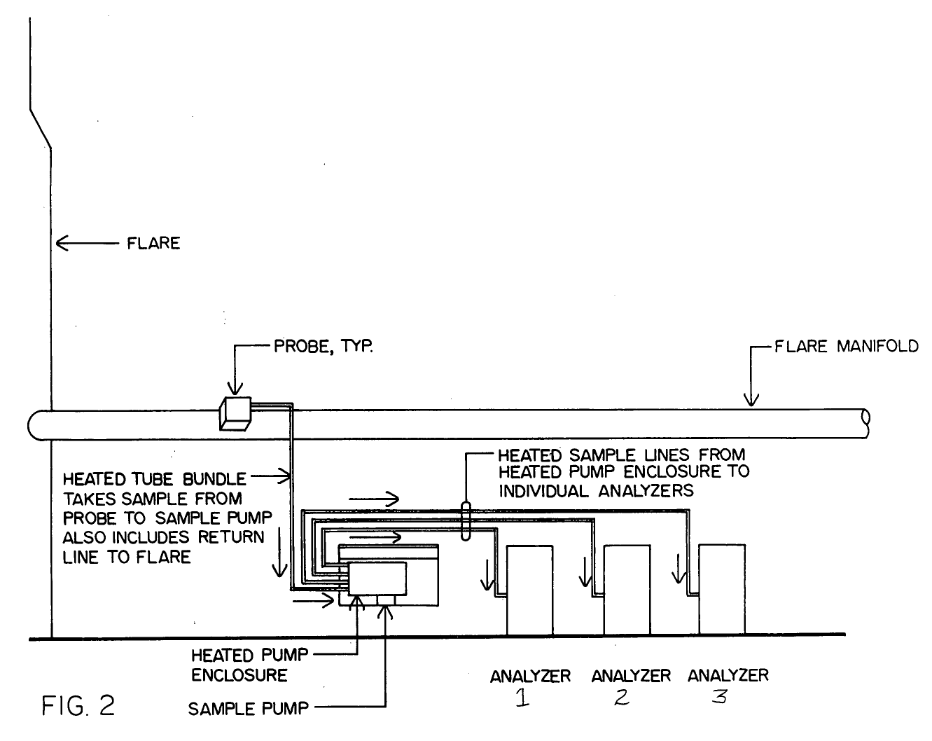

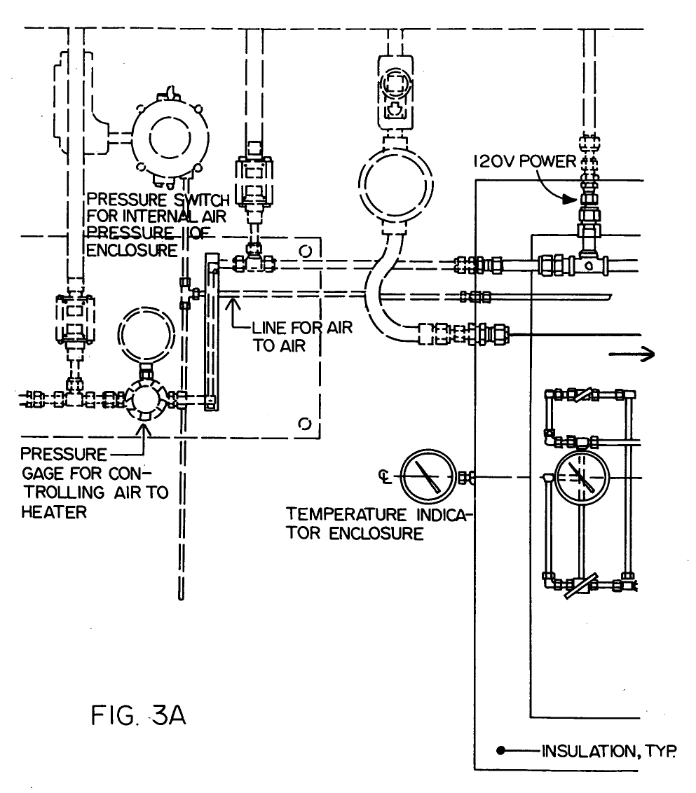

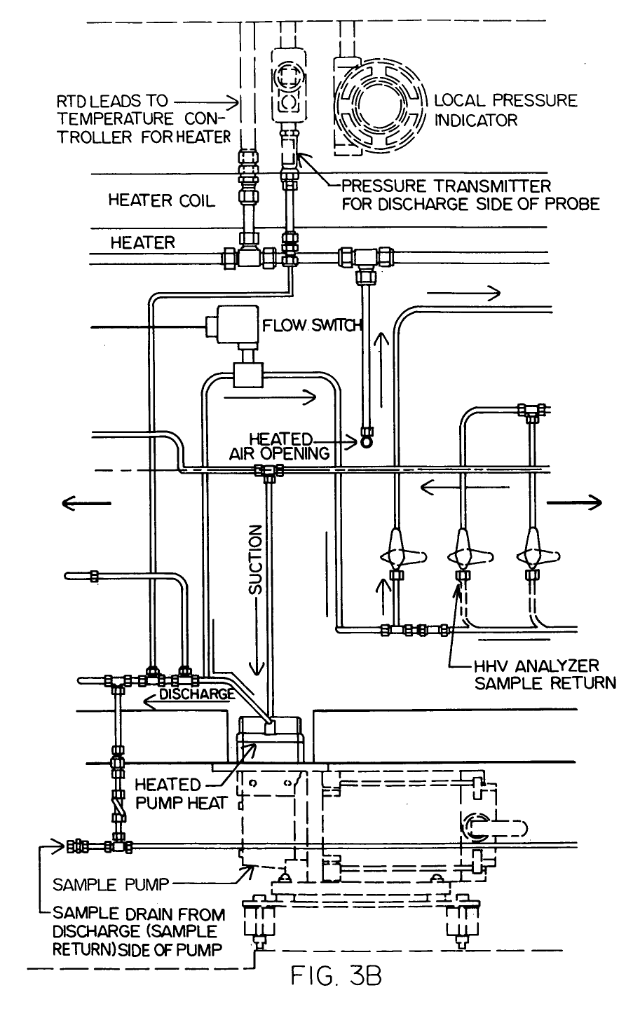

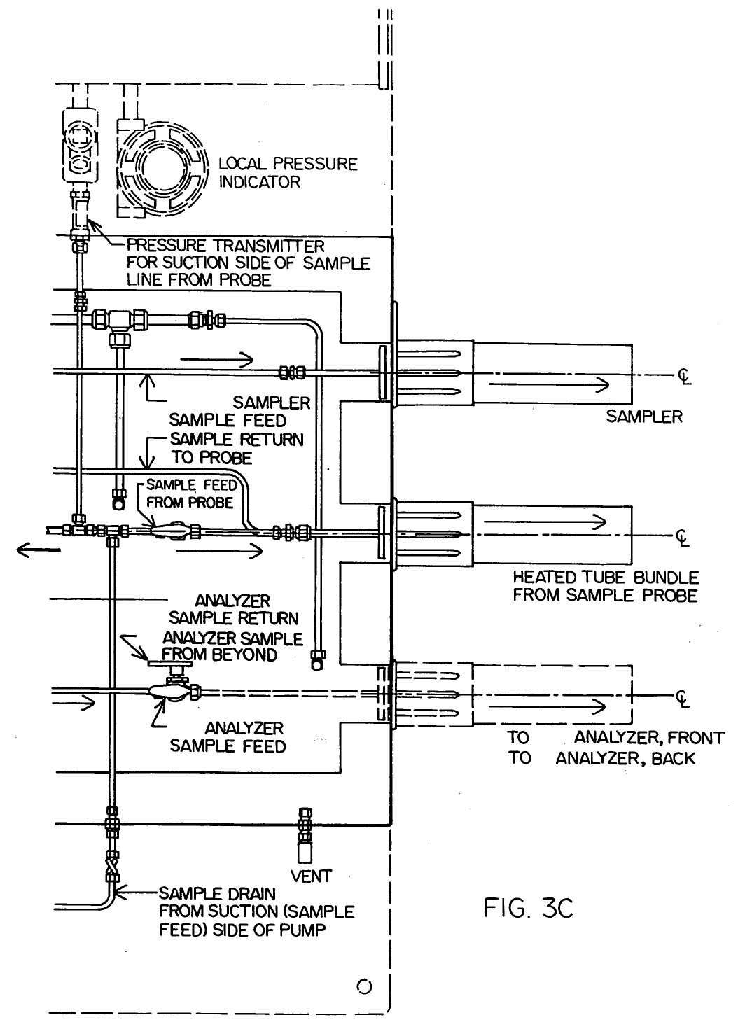

FIG. 1 illustrates the prior art method of gathering samples from the flare manifold and distributing the sample to the various analyzers involved. As can be seen each analyzer requires its own system of delivery, pump and probe. FIG. 2 illustrates the Heated Pump Assembly as the sole recipient of the heated tube line from the only probe mounted on the flare manifold. From the Heated Probe Assembly multiple heated tube lines are distributed to the analyzers, as many analyzers as required. FIG. 3, consisting of FIGS. 3A, 3B and 3C, is an interior view of the Heated Pump Assembly.

The various features of the Heated Pump Assembly are identified in FIG. 3. Starting with FIG. 3C, the heated tube bundle from the probe is shown entering the heated enclosure. It is routed to the suction side of the pump head, which is located at the bottom of the enclosure (FIG. 3B). After the sample side is discharged from the pump head, it is routed through a series of tubing tee's and valves to the various heated tube bundles that exit the heated enclosure. In FIG. 3C they are identified as the analyzer 1, sampler and the analyzer 2. The heater for the heated enclosure is located in the upper left hand side of the enclosure (FIG. 3B). The heater has an air line that feeds it from its left horizontal port, which blows past the 120 VAC port where the actual heater coil is located, and then through another port where the RTD's (Resistance Thermistor Devices) are located, then through a series of tubing changes, the air is distributed throughout the interior of the heated enclosure. This system provides the air bath required to keep the enclosure at the required temperature. The RTD's are connected to an external temperature controller, which automatically adjusts the heater coil to maintain the required temperature. A low-pressure switch is shown on the upper left hand side of FIG. 3A. This maintains positive pressure in the enclosure so that any fugitive vapors or gases can be forced out the vent located on the lower bottom right hand side of the enclosure (FIG. 3C). This allows one to maintain a Class 1, Division 2 classification instead of Class 1, Division 1 area within the heated enclosure even though closed systems containing vapors, gases or liquids are present and they normally would be considered hazardous in such an environment with high temperatures.

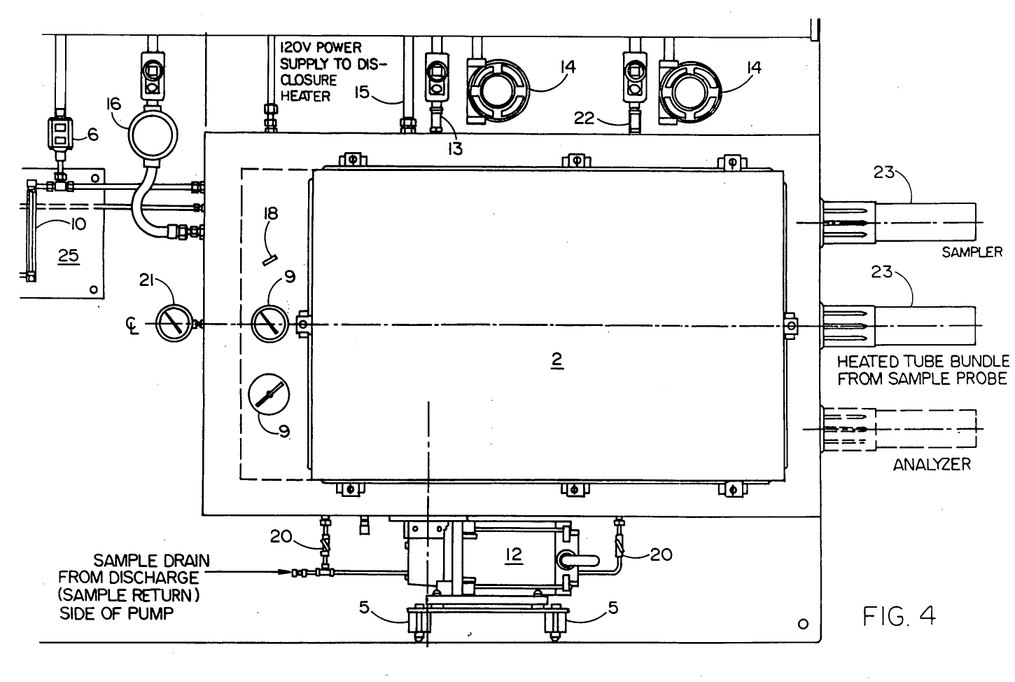

FIG. 4 is an exterior view of the Heated Pump Assembly. The Heated pump assembly is meant to be mounted in the field and external connections fitted to it. These external connections include, but are not be limited to, instrument air, 120V power, RTD's to a temperature controller, signals to a PLC or other items as required. The major components are: (1) the mounting plate, (24) a NEMA 4× stainless steel wire-way, (2) the heated enclosure and (12) the sample pump. To the left of the heated enclosure is the instrument air feed for the heater (6), (7), (8) and (10). The low air pressure switch (11) is located here as well. On the top of the enclosure are mounted the pressure indicators and transmitters (13), (14), (15) and (22). The flow switch is mounted inside the enclosure but the connections for the pigtails are located inside a fitting identified as (16). A temperature indicator for monitoring the inside temperature of the enclosure is located on the left-hand side of the enclosure (21). Mounted on the front of the enclosure to the left is the instrumentation required to regulate back pressure for the tubing inside of the enclosure (9) and (18). A ½″ vent for relieving air pressure in the enclosure is located on the bottom of the enclosure. Also exiting the bottom of the enclosure are two drains, one each for the suction and discharge sides of the pump. These would be employed when routine maintenance is performed on the pump, necessitating that the pump be removed from the enclosure. One would drain excess sample from the lines before the pump is removed.

HEATER SYSTEM: The heater (17) shown in FIG. 3A is powered by a 120V power source located in a temperature controller. The 120V power heats up a coil that will reach the desired temperature of 300° F. To the right of the 120V on the heater is located a vertical port were the RTD wires are landed; these are also attached to the same temperature controller that drives the heater coil. Mounted on a clear plastic plate (25) outside of the heated enclosure is the air pressure gauge with an indicator. This is set at 40 PSI and is used to regulate the air flow in into heater. As the instrument air passes over the heater coils it is blown over the RTD's, which are used to determine the temperature of the air as it is expelled into the heated enclosure. The temperature controller regulates the heater coil based on these readings.

The low pressure regulator (11) is piped into the heated enclosure. When it senses a loss of air pressure it sends a signal to a PLC, which then energizes a solenoid, which controls the flow of bottled instrument air to the Heated Pump Enclosure. Bottled air is then delivered to the heater in the same line as the plant instrument air. Thus there is no loss of positive pressure in the enclosure. Once the bottle air is employed, the temperature controller shuts off the power to the heater coil preventing it from running while bottled gas is in use. At the same time, an alarm is triggered to the appropriate control room in the refinery indicating a loss/disruption of plant air. A reset button is used once all three of the following conditions have been met: the bottle air solenoid is de-energized, the plant instrument air is operating and at a pressure that is acceptable and the heater coil power is off. This shutdown system is essential to the safe operation of the Heated Pump Enclosure. As indicated above, the tubing used to deliver samples from the probe, carries vapor, gases or liquids that would be easily ignited in such an atmosphere. By keeping the enclosure positively pressurized, any fugitive vapors, gases or liquids can be driven out through the vent without endangering the integrity of the enclosure. This allows the equipment encapsulated within the heated enclosure to meet the constraints of hazardous area requirements for Class 1, Division 2 while operating at high temperatures.

SAMPLE PUMP: The sample pump (12) is located at the bottom of the heated enclosure. It is supported by a series of brackets (5) in this particular case, but it could be easily supported by other means. The pump head, which has suction and discharge ports, is located inside the heated enclosure. The bolts that are located on a plate attached to the pump head, allow the pump head to be attached to the heated enclosure. The tubing and insulation are designed so that the pump head can be easily accessed for maintenance.

HEATED ENCLOSURE: The opening to the interior of the heated enclosure is accessed by an insulated door that is also rated Nema 4×. It is attached by series of clips with bolts; however it could just as easily be hinged. The entire interior of the heated sample enclosure is insulated with 2″ of insulation and then is lined with a sheet metal guard. The heated tube bundle (23) from the probe is fitted into a boot, which has been pre-attached to the right-hand side of the heated enclosure. A hot air device, similar to a hair dryer, shrinks the boot around the heated tube line. The sample feed and return lines are then routed into the heated enclosure. The sample feed line is routed through a valve to the suction side of the heated pump head. This valve is used to isolate the pump from the sample line when it is being repaired. Before the sample feed line from the probe reaches the suction side, it is tee'd off to the suction side pressure indicator, the suction side drain and to the back pressure regulator. After being discharged by the pump, the sample line is tee'd off to various instruments for monitoring; the return for the back pressure regulator, the discharge side pressure regulator, the discharge side drain, flow and then it is routed to a manifold of valves. These valves route the discharge side of the pump to any number of heated tube bundles feeding various pieces of equipment. In the case of the accompanying drawings, it is shown being routed to a sampler system, TS Analyzer and a HHV analyzer as examples. This is a unique feature of this system; only one sample line from a single probe is needed to feed a multiplicity of samples to exterior devices such as analyzers and sampling systems.

The sample return line like the sample feed line is also fitted with a valve after it enters the heated enclosure. Through a series of tubing tee's and valves the return line from the analyzers and sample systems, route the used sample to this return line. This return line then is routed through the heated tube bundle back to the probe, where used sample is dumped back into the flare manifold. Material in contact with the flare sample is coated with special non-sulfur absorbing lining.

Once the heated tube bundle is “booted” and the sample lines enter the heated enclosure, the tubing is not insulated until it leaves the heated enclosure. The heater ensures that the exposed sample lines are consistently heated to 300° F. so the sample is not degraded by low temperatures.

While, in the foregoing, embodiments of the present invention have been set forth in considerable detail for the purposes of making a complete disclosure of the invention, it may be apparent to those of skill in the art that numerous changes may be made in such detail without departing from the spirit and principles of the invention. Accordingly, the scope of the invention hereof is to be deemed limited only by the appended claims and their equivalents with the words thereof being understood to having their ordinary meanings as one of ordinary skill in the relevant arts would understand them.

We claim:

1. A flare sampling apparatus for installation at oil refineries to provide sample flare gas to a plurality of analyzers to assess the content thereof; the apparatus comprising:
a heated enclosure receiving said flare gas from an insulated line; and a pump head contained within said enclosure for directing said flare gas to said analyzers at an elevated temperature.

2. The flare sampling apparatus recited in claim 1 further comprising an air bath device within said enclosure for maintaining a substantially constant elevated temperature throughout the interior of said enclosure.

3. The flare sampling apparatus recited in claim 1 further comprising a safety shutdown system for safely terminating operation of said apparatus.

4. The flare sampling apparatus recited in claim 1 is comprised of further comprising components which meet or exceed the required hazardous location certification standards common to operation of electrical devices near refinery flares.

5. A method for use in oil refineries of sampling a flare gas system using a plurality of analyzers and a unitary manifold probe; the method comprising the steps of:
providing a heated enclosure between said probe and said analyzers; and
locating at least the head of a pump within said enclosure for receiving a flare sample from said probe and transmitting high temperature flare sample gas to said analyzers.

6. The method recited in claim 5 further comprising the step of producing an air bath flow within said enclosure for distributing heat therein.

7. The method recited in claim 5 further comprising the step of implementing a safety shutdown system within said enclosure for terminating sampling operations at the occurrence of an interruption event.

8. The method recited in claim 5 further comprising the step of employing components in said heated enclosure which meet or exceed required hazardous location certification standards for operation of electrical devices near refinery flares.
